(19) United States
(12) Patent Application Publication
(10) Pub. No.: US 2006/0130497 A1
(43) Pub. Date: Jun. 22, 2006

(54) Method and control for testing air filter condition in HVAC system

(75) Inventors: Pengju Kang, Hartford, CT (US); Thomas D. Radcliff, Vernon, CT (US); Mohsen Farzad, Glastonbury, CT (US); Alan M. Finn, Hebron, CT (US)

Correspondence Address: CARLSON, GASKEY & OLDS, P.C., 400 WEST MAPLE ROAD, SUITE 350, BIRMINGHAM, MI, 48009, US

(73) Assignee: Carrier Corporation

(21) Appl. No.: 11/017,431

(22) Filed: Dec. 20, 2004

(51) Int. Cl. F01P 7/04; F25B 49/00; G01K 13/00; F25D 17/00

(52) U.S. Cl. 62/127; 62/129; 62/180

(57) ABSTRACT

A method and control for determining an air filter condition in an HVAC system forces a change in a motor speed for a fan for driving air through the air filter and into an environment to be conditioned. When the motor speed is changed, an expected change in temperature in the environment is monitored. If the actual change is not as expected, a determination may be made that the air filter is clogged.

### BACKGROUND OF THE INVENTION

This application relates to a method and control for testing the condition of an air filter, and identifying when the air filter should be replaced based upon forcing a change in one system condition, and then monitoring a corresponding change in another condition indicative of the condition of the air filter.

Heating, ventilation and air conditioning systems (HVAC) typically include a fan driving air over a heat exchanger, and into an environment to be conditioned. The heat exchanger could be an evaporator to cool the air, a portion of a furnace, or a condenser in a heat pump to heat the air. In all such systems, the air flowing into the environment typically passes through an air filter. Over time, the air filter can become clogged. Various ways have been developed for identifying when the air filter is clogged and should be replaced. Traditionally, a routine maintenance has been recommended in which the air filter would be replaced on some periodic basis. One downside with this method is that often the periodic maintenance does not occur, as an occupant of the building having the HVAC system neglects to change the air filter.

In the past, various conditions are monitored to determine the condition of the filter. However, it would be desirable to have a more active method for identifying a clogged filter.

### SUMMARY OF THE INVENTION

In a disclosed embodiment of this invention, one condition within an HVAC system is changed, and a resultant change in another condition is monitored. In the disclosed embodiment, the speed of the fan motor blowing air into the environment, and hence through the air filter is changed. A resultant change in a condition within the environment is monitored. In the disclosed embodiment, the monitored condition is temperature. By monitoring the actual change in the temperature, and comparing it to an expected change, a prediction of the filter condition can be made.

A method and control is disclosed for utilizing this concept. If a clogged filter is identified, some warning is actuated.

In one disclosed embodiment, the fan motor speed is changed until a resultant change in temperature is detected. The time that it takes for the resultant change in temperature to occur with the changing fan motor speed is compared to an expected time and a prediction is made based upon this comparison.

In a second method, a step change in the fan motor speed is induced, and the resultant change in temperature is monitored. The time it takes for the temperature to reach a predetermined changed value is compared to an expected time. Again, a prediction is made of the filter condition based upon this comparison.

In the third disclosed embodiment, a random number generator randomly changes the fan motor speed, and the resultant change in temperature is monitored. Again, if the expected change does not equal the actual change, then a determination may be made that the filter is in need of replacement.

These and other features of the present invention can be best understood from the following specification and drawings, the following of which is a brief description.

### BRIEF DESCRIPTION OF THE DRAWINGS

FIG. 1 is a schematic view of a refrigerant system incorporating the present invention.

FIG. 1A shows an alternate embodiment.

FIG. 2 shows a control portion of the FIG. 1 embodiment.

FIG. 3 is a graph of a first method of the present invention.

FIG. 4 shows the first embodiment of the invention with a filter that is clogged.

FIG. 5 shows a second embodiment of this invention.

FIG. 6 is a control schematic of a third embodiment of this invention.

### DETAILED DESCRIPTION OF THE PREFERRED EMBODIMENT

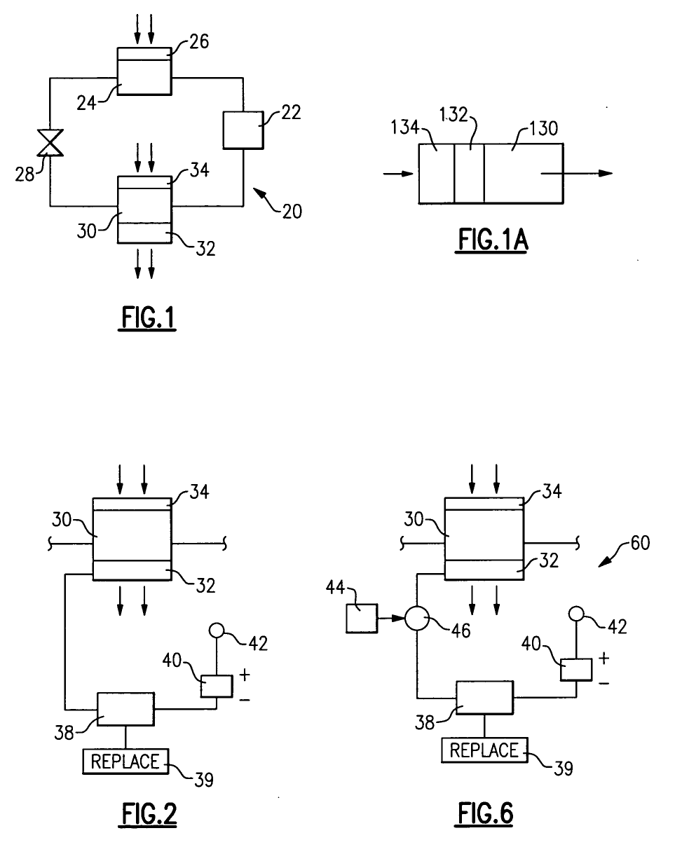

FIG. 1 shows a refrigerant system 20 incorporating a compressor 22 delivering a refrigerant to an outdoor heat exchanger 24. A fan 26 delivers air over the heat exchanger 24. Downstream of the heat exchanger 24, the refrigerant passes through an expansion device 28, and then moves to an indoor heat exchanger 30. While the present invention may be utilized in a heat pump that may either heat or cool an environment, the simple schematic of FIG. 1 shows an air conditioner for cooling the environment. By including a four-way valve for routing refrigerant from the compressor to either the outdoor heat exchanger 24, or to the indoor heat exchanger 30, both heating and cooling can be selectively achieved as known. In the simple embodiment shown in FIG. 1, the refrigerant cycle 20 is a cooling cycle, such as an air conditioner.

In FIG. 1, a fan 32 pulls air through an air filter 34, and over the heat exchanger 30. As shown in FIG. 1A, the fan 32 pulls air through an air filter 134, and over a furnace heat exchanger 130. In either embodiment, air is then delivered into an environment to be conditioned. The following description will be made with regard to the FIG. 1 embodiment, but would also extend to the FIG. 1A embodiment.

As shown in FIG. 2, a control loop is associated with the fan 32. The control loop includes a controller 38 communicating with a signaling device 39 such as a light, buzzer, etc. which will provide an indication that the air filter 34 should be replaced if conditions suggest that it should be replaced.

The controller 38 is operable to change the speed of the fan motor in fan 32. As the speed of the fan changes, the airflow over the heat exchanger 30 changes, and one would expect the temperature in the environment such as sensed by temperature sensor 42 would also change. An expected change based upon a particular change in the motor speed driven by controller 38 is determined at a summation box 40. Summation box 40 takes in the actual monitored temperature from temperature sensor 42, and compares it with an expected temperature based upon the change in motor speed. A determination may be made between controller 38 and summation box 40 that the filter is in need of replacement, as will be explained below.

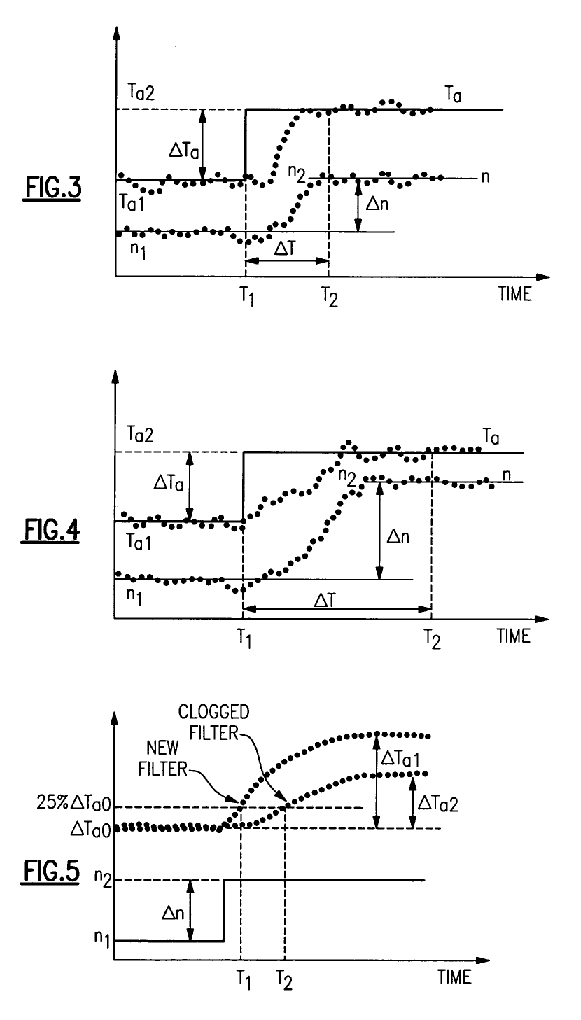

FIG. 3 shows a change in motor speed n, and a resultant change in the indoor temperature T. FIG. 4 shows a similar change. FIG. 3 and FIG. 4 show a first embodiment in which the motor speed is increased until the temperature changes through a particular temperature ΔT. Thus, the motor speed is increased until the summation box 40 sees that the temperature sensed by sensor 42 is equal to a new temperature spaced from an original temperature by an amount ΔT. The amount of change in the motor speed, Δn, that was required to achieve ΔT is then determined. This change in motor speed Δn is compared to limits, and if the change in motor speed An is greater than expected, as for instance illustrated in FIG. 4, then a determination is made that the filter 34 is in need of replacement. The signaling device 39 may then be lit, etc.

FIG. 5 shows another embodiment wherein a single step change Δn is forced on the motor speed. The time it takes for the temperature to change to a particular new temperature is then monitored. As an example, a change to reach 25% of a new temperature T is monitored. The top line shows an expected response from a newer filter, that crosses a line at a time T₁. The bottom line illustrates the response from a clogged filter, and takes until a time T₂ to cross the same line. Alternatively, one can wait for a steady state response and monitor the total ΔT rather than the time. With this embodiment, a particular change in the motor speed is forced, and the resultant change is monitored.

FIG. 6 shows another embodiment 60 wherein a pseudo-random number generator 44 drives varying and random changes into a control box 46. Control box 46 changes the motor speed at the motor for fan 32, and also supplies the pseudo-random change to the control 38. Again, the change in temperature 42 is monitored, and compared to expected changes. The control 38 can then determine whether the filter is in need of replacement based upon these changes.

In sum, a change is forced in a system condition, and a resultant change in another system condition is monitored to see if it is indicative of a clogged filter. In the disclosed embodiment, a change in the fan speed for driving air through the air filter and into an environment to be conditioned is changed, and the resultant change in temperature is monitored.

The testing of filter condition can occur periodically on some schedule.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An HVAC system comprising:
a heat exchanger to heat air to be delivered into an environment to be conditioned;
a fan for driving air over said heat exchanger;
an air filter for receiving air to be delivered into the environment and for removing impurities in the air, air being driven through said air filter by said fan; and
a control for changing at least one variable within the HVAC system, and for monitoring a resultant change in another variable, said control being programmed to determine a condition of said air filter based upon said resultant change.

2. The HVAC system as set forth in claim 1, wherein said control changes a speed of a motor for said fan, and monitors a resultant change in an air temperature to determine the condition of the air filter.

3. The HVAC system as set forth in claim 2, wherein said control provides an indication that an air filter is in need of replacement if a determination is made that said air filter is in need of replacement.

4. The HVAC system as set forth in claim 2, wherein said control changes a motor speed until a particular resultant change in detected temperature occurs, and then compares the amount of change in motor speed required to effect the particular resultant change to determine the condition of said air filter.

5. The HVAC system as set forth in claim 2, wherein a particular step change in motor speed is forced, and a resultant change in detected temperature is monitored to determine the condition of said air filter.

6. The HVAC system as set forth in claim 2, wherein a random number generator generates random changes in motor speed, and said random changes in motor speed and detected resultant changes in temperature are utilized to determine the condition of said air filter.

7. A control comprising:
a control for changing at least one variable within an HVAC system, and for monitoring a resultant change in another variable, said control being programmed to determine the condition of an air filter based upon said resultant change.

8. The control as set forth in claim 7, wherein said control changes a speed of a motor for a fan, and monitors a resultant change in an air temperature to determine the condition of the air filter.

9. The control as set forth in claim 8, wherein said control provides an indication that an air filter is in need of replacement if a determination is made that the air filter is in need of replacement.

10. The control as set forth in claim 8, wherein said control changes a motor speed until a particular resultant change in detected temperature occurs, and then compares the amount of change in motor speed required to effect the particular resultant change to determine the condition of said air filter.

11. The control as set forth in claim 8, wherein a particular step change in motor speed is forced by said control, and a resultant change in detected temperature is monitored to determine the condition of said air filter.

12. The control as set forth in claim 8, wherein a random number generator generates random changes in motor speed, and said random changes in motor speed and detected resultant changes in temperature are utilized by said control to determine the condition of said air filter.

13. A method of determining the condition of an air filter in an HVAC system comprising the steps of:
(1) providing an HVAC system including a heat exchanger, a fan for driving air over the heat exchanger and into an environment to be conditioned, and an air filter for receiving and filtering air being delivered by said fan into said environment;
(2) changing a system variable, and monitoring a resultant change in a second system variable, and determining the condition of said air filter based upon said resultant change.

14. The method as set forth in claim 13, wherein said control changes a speed of a motor for said fan, and monitors a resultant change in an air temperature to determine the condition of the air filter.

15. The method as set forth in claim 14, wherein said control provides an indication that said air filter is in need of replacement if a determination is made that said air filter is in need of replacement.

16. The method as set forth in claim 14, wherein said control changes a motor speed until a particular resultant change in detected temperature occurs, and then compares the amount of change in motor speed required to effect the particular resultant change to determine the condition of said air filter.

17. The method as set forth in claim 14, wherein a particular step change in motor speed is forced, and a resultant change in detected temperature is monitored to determine the condition of said air filter.

18. The method as set forth in claim 14, wherein a random number generator generates random changes in said motor speed, and said random changes in motor speed and detected resultant changes in temperature are utilized to determine the condition of said air filter.
